(19) United States
(12) Patent Application Publication
(10) Pub. No.: US 2014/0179375 A1
(43) Pub. Date: Jun. 26, 2014

(54) PROTECTION CASE FOR MOBILE PHONE AND MOBILE APPARATUS

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/025,835

(22) Filed: Sep. 13, 2013

(30) Foreign Application Priority Data
Dec. 24, 2012 (CN) 2012105653043

(51) Int. Cl. H04B 1/38

(52) U.S. Cl. CPC H04B 1/3888
USPC 455/566

(57) ABSTRACT

A mobile phone protection case for encasing a mobile phone to protect the mobile phone from being damaged with a bluetooth unit is provided. The protection case includes a display screen, a bluetooth unit, and a display control unit. The bluetooth unit is configured to receive an radio signal carrying ID information in relation to a call or both ID information and content of a short message transmitted from the bluetooth unit of the mobile phone. The display control unit is configured to generate a video signal according to the received audio signal and control the display screen to display the ID information of the call or both the ID information and the content of the short message to user of the mobile phone. A mobile apparatus is also provided by the present disclosure.

### BACKGROUND

1. Technical Field

The present disclosure relates to a protection case for mobile phone and a mobile apparatus.

2. Description of Related Art

Mobile phones are generally received in protection cases to prevent the mobile phones from being scratched. However, there is a need to add other functions to the protection case to enrich usefulness.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a mobile phone protection case and a mobile phone, in accordance with an exemplary embodiment of the present disclosure.

FIG. 2 is a block diagram of the mobile phone protection case and the mobile phone in FIG. 1.

FIG. 3 is a schematic view of the mobile phone protection case displaying information in accordance an exemplary embodiment of the present disclosure.

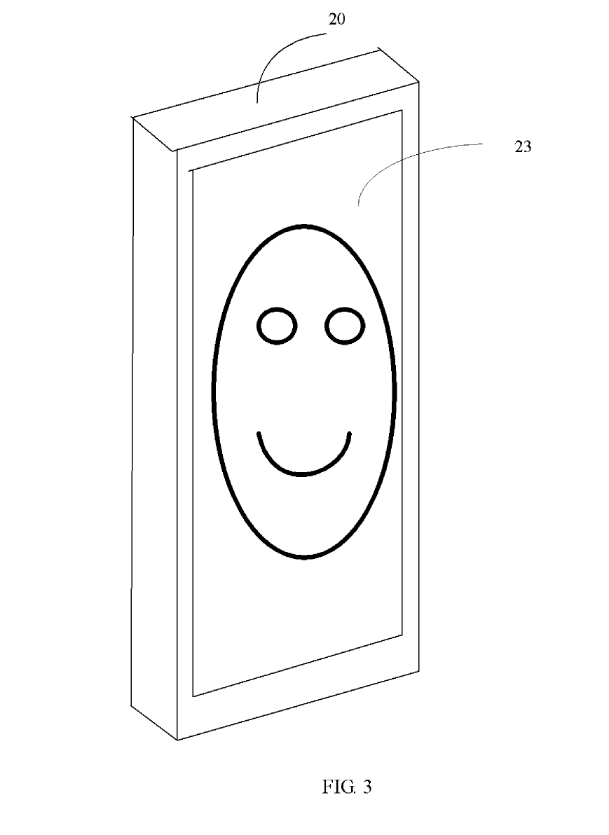

### DETAILED DESCRIPTION

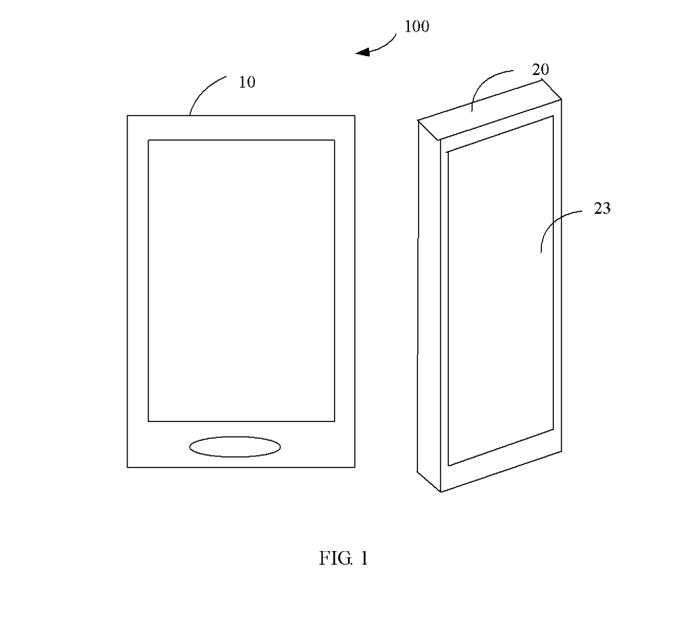

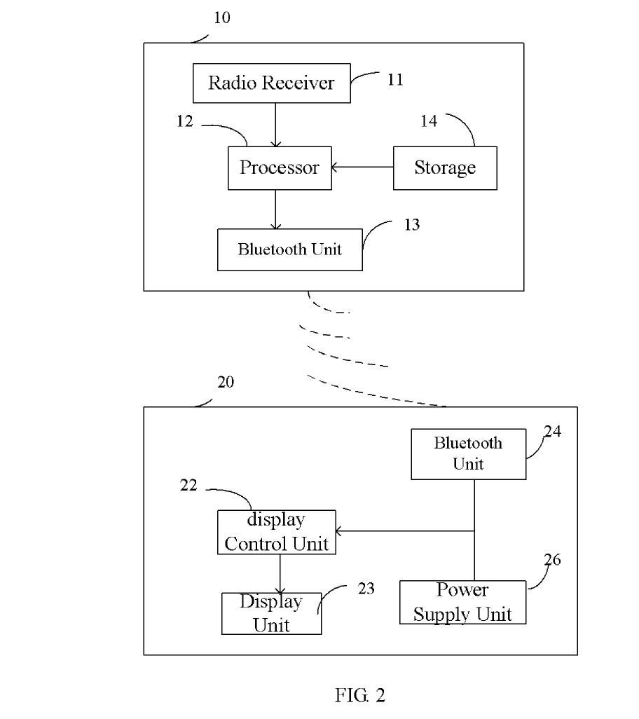

FIGS. 1-2 show a mobile apparatus 100 in accordance with an exemplary embodiment. The apparatus 100 includes a mobile phone 10 and a protection case 20 for encasing the mobile phone 10.

The mobile phone 10 includes a radio receiver 11, a processor 12, an bluetooth unit 13 and a storage 14. The storage 14 stores a telephone directory. The telephone directory includes a number of contact members. Each contact member is represented by at least one item selected from the group consisting of a name, a telephone number, and a picture such as portrait of the contact member. When the mobile phone 10 receives a call or a piece of short message from any of the contact members, the mobile phone 10 displays his or her name, or telephone number, or picture, which all are referred as the “ID information”.

The radio receiver 11 is configured to receive radio waves from the telephone network stations when communication information should be transmitted to the mobile phone 10 from the telephone network stations and generates a signal corresponding to the received radio waves. The communication information may be calls, or short messages, for example, and includes the ID information of a contact member who sends the short message or makes the call.

The processor 12 is configured to obtain the ID information in relation to the call or the short message according to the telephone number of the call or short message and generate a radio signal corresponding to the ID information, and transmit the radio signal to the mobile phone protection case 20 by the bluetooth unit 13. In the embodiment, if the communication information is a call and the storage 14 already stores the ID information of contact member, the processor 12 transmits the ID information to the protection case 20 by the bluetooth unit 13; if the storage 14 does not store the ID information of the contact member, the processor 12 transmits the contact member's telephone number to the protection case 20 by the bluetooth unit 13. If the communication information is a text message, the processor 12 also transmits the content of the short message to the protection case 20 by the bluetooth unit 13.

The mobile phone protection case 20 includes an bluetooth unit 21, a display control unit 22 and a display unit 23. The display unit 23 is mounted on the outer side of the case 20 to display the ID information and the communication information. A user can obtain the communication information and the ID information through the display unit 23 without taking the mobile phone 10 out of the protection case 20. In the embodiment, the display unit 23 is a light emitting diode (LED) screen or a liquid crystal display (LCD) screen. The bluetooth unit 21 is configured to receive radio signal transmitted from the mobile phone 10. The radio signal carries the ID information of a call or both ID information and the content of a short message. The display control unit 22 is configured to generate a video signal according to the radio signal, the video signal carries the ID information of the call or carries both the ID information and the content of the short message and controls the display unit 23 to display the ID information or further the content of the short message to user of the mobile phone 10.

In other embodiments, the mobile phone protection case 20 includes a power supply unit 26 to supply power for all power-driven elements of the case 20 such as the display unit 23 and the display control unit 22.

The protection case provided by the present disclosure has a display screen on and can display ID information and communication information of incoming calls and short messages on the display screen. Therefore, user can obtain the caller and the communication information from the protection case without needing to take out the mobile phone from the protection case.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A mobile phone protection case, for encasing a mobile phone having a bluetooth unit to protect the mobile phone from being scratched, comprising:
a display unit;
a bluetooth unit configured to receive a radio signal carrying ID information of a call or both ID information and content of a short message transmitted from the bluetooth unit of the mobile phone;
a display control unit configured to generate a video signal according to the received radio signal and control the display screen to display the ID information of the call or both ID information and the content of the short message to user of the mobile phone.

2. The mobile phone protection case as described in claim 1, wherein the ID information comprises at least one item selected from the group consisting of a telephone number, or a name, and a picture representing a contact member who makes the call or sends the short message to the mobile phone.

3. The mobile phone protection case as described in claim 2, wherein the picture is a portrait of the contact member.

4. The mobile phone protection case as described in claim 1, wherein the protection case comprises a power unit to supply power to the display screen and the display control unit.

5. A mobile apparatus, comprising:
a mobile phone; and
a mobile phone protection case encasing the mobile phone therein,
wherein:
the mobile phone comprising:
a bluetooth unit;
a radio receiver configured to receive radio waves in response to a call or a short message from telephone network stations;
a processor configured to obtain ID information of the call or the text message according to the telephone number of the call or the short message and generate an radio signal carrying the ID information of the call or both the ID information and content of the short message and transmit the radio signal to the mobile phone protection case through the bluetooth unit;
the mobile phone protection case comprising:
a display screen;
a bluetooth unit configured to receive the radio signal transmitted from the bluetooth unit of the mobile phone;
a display control unit configured to generate a video signal according to the received audio signal and control the display screen to display the ID information of the call or the ID information and the content of the short message to user of the mobile phone.

6. The mobile phone apparatus as described in claim 5, wherein the mobile phone comprises a storage storing a telephone directory consisting of a plurality of contact members and ID information representing each of contact members.

7. The mobile phone apparatus as described in claim 6, wherein the ID information comprises at least one item selected from the group consisting of a name, a telephone number, and a picture.

8. The mobile apparatus as described in claim 7, wherein the picture is a portrait of the contact member.

9. The mobile phone apparatus as described in claim 7, wherein the mobile phone comprises a storage to store the ID information of a contact member.

10. The mobile phone apparatus as described in claim 5, wherein the protection case further comprises a power unit to supply power to the display screen and the display control unit.
